(19) United States
(12) Patent Application Publication
(10) Pub. No.: US 2008/0308981 A1
(43) Pub. Date: Dec. 18, 2008

(54) Plastic Ring for Removably Fixing a Round Shank Chisel in a Chisel Bush

(76) Inventor: Robert Exel, Seckau (AT)

Correspondence Address: DICKSTEIN SHAPIRO LLP, 1825 EYE STREET NW, Washington, DC, 20006-5403, US

(21) Appl. No.: 11/918,348

(22) PCT Filed: Mar. 31, 2006
(86) PCT No.: PCT/AT2006/000130

§ 371 Date: Nov. 15, 2007

(30) Foreign Application Priority Data
Apr. 14, 2005 (AT) A 632/2005

(51) Int. Cl. F16F 1/366

(52) U.S. Cl. 267/292

(57) ABSTRACT

A plastic ring (9) for detachably fixing a rounded-shaft tool (1) into a tool bushing (6), wherein the inside of the tool bushing (6) has an annular groove (7), into which the elastic plastic ring (9) held in an annular groove (3) of the tool shaft (2) engages, is designed in a slotted fashion and has at least one rib projecting beyond the outer surface of the plastic ring (9) and extending across at least a portion of the periphery of the plastic ring (9). In order to achieve a proper hold of the rounded-shaft tool (1), the cross-section of the plastic ring (9) exhibits a section (11) which can be pushed inwards and springs outwards in a radial direction and extends across at least a portion of the periphery of the plastic ring (9), wherein said section (11) can be pushed relative to the other sections of the cross-section of the plastic ring (9) from a relaxed initial position with a particular outside diameter (12) larger than the inside diameter (6′) of the tool bushing (6) into a fitting position exhibiting a smaller outside diameter corresponding to the inside diameter (6′) of the tool bushing (6) and is able to spring back into the relaxed initial position, whereby the total thickness (15) of the relaxed plastic ring (9) exceeds the depth (4) of the annular groove (3) of the tool shaft (2).

The invention concerns a plastic ring for detachably fixing a rounded-shaft tool into a tool bushing, wherein the inside of the tool bushing has an annular groove, into which the elastic plastic ring held in an annular groove of the tool shaft engages, with the plastic ring being designed in a slotted fashion and having at least one rib projecting beyond the outer surface of the plastic ring and extending across at least a portion of the periphery of the plastic ring.

Rounded-shaft tools are detachably fastened to drilling heads and drilling rolls, respectively, so that they can be replaced upon wear with an amount of work as small as possible. The demand for a proper hold of the rounded-shaft tools on the drilling heads and drilling rolls, respectively, is contradictory to the demand for easy detachability, particularly since said tools are exposed to relatively high centrifugal forces and transverse forces. A further requirement with respect to the fastening of a rounded-shaft tool to a tool bushing is insensitiveness to harsh operating conditions, aggravated by fine particles and cooling liquid etc. In addition, these operating conditions should also not hamper the removal of a rounded-shaft tool from its tool bushing.

A plastic ring for detachably fixing a rounded-shaft tool into a tool bushing of the initially described type is known from AT 004 193 U1. According to this document, the insertion of the rounded-shaft tool into the tool bushing is accomplished due to the fact that the depth of the annular groove of the tool shaft exceeds the total thickness of the plastic ring in the area of the rib thereof and that the slot has such a width that, for the assembly, the plastic ring is reducible in diameter to such an extent that the plastic ring will not project beyond the diameter of the tool shaft in the area of the annular groove when the rounded-shaft tool is inserted into the tool bushing. When a rounded-shaft tool is installed, the plastic ring is reduced in diameter to such an extent that it will fit entirely into the annular groove of the rounded-shaft tool, whereby its rib is prevented from obstructing the insertion of the rounded-shaft tool.

Not until the rounded-shaft tool has achieved the correct fit in the tool bushing will the plastic ring spring off, and the rib of the plastic ring engages at least partially into the annular groove provided at the inner jacket of the tool bushing. Thus, according to the prior art, the retention force is produced by the spring-off of the plastic ring from an outside diameter smaller than or equal to, respectively, the outside diameter of the rounded-shaft tool onto a diameter exceeding said outside diameter.

It has been shown that the retention force thus produced is often insufficient for the harsh drilling operation. The centrifugal forces lead to an unintended removal of a rounded-shaft tool from the tool bushing, which is promoted by inclined walls of the rib and of the annular groove which is designed in a fashion corresponding thereto.

It is the object of the invention to provide a plastic ring of the initially described type, by means of which easy insertion of a rounded-shaft tool into the tool bushing as well as easy removal become possible, while, however, a sufficiently firm fit of the rounded-shaft tool in the tool bushing is provided during operation. Thus, the object is to meet two entirely contrasting requirements.

According to the invention, said object is achieved in that the cross-section of the plastic ring exhibits a section which can be pushed inwards and springs outwards in a radial direction and extends across at least a portion of the periphery of the plastic ring, wherein said section can be pushed relative to the other sections of the cross-section of the plastic ring from a relaxed initial position with a particular outside diameter larger than the inside diameter of the tool bushing into a fitting position exhibiting a smaller outside diameter corresponding to the inside diameter of the tool bushing and is able to spring back into the relaxed initial position, whereby either the total thickness of the relaxed plastic ring exceeds the depth of the annular groove of the tool shaft or the slot has a width which is dimensioned such that, with a reduction in the diameter of the plastic ring until the side walls of the slot contact each other, the radially elastic section of the cross-section of the plastic ring projects beyond the outside diameter of the tool shaft when the plastic ring is inserted in the annular groove.

Thus, the basic concept of the invention is that the penetration of the plastic ring, i.e., of its rib extending across at least a portion of the periphery, into the groove of the tool bushing is not effected by a radial spring-off of the entire plastic ring, but due to the fact that the rib itself is designed in an elastic fashion and springs forward radially across the outer circumference of the plastic ring. In principle, this can occur in two ways. Firstly, as a result of the total thickness of the plastic ring being larger than the depth of the annular groove of the tool shaft or due to the fact that the plastic ring still projects at least with its rib beyond the outside diameter of the tool shaft even if its slot is compressed.

According to a first preferred embodiment, the cross-section of the plastic ring has a wavelike design, wherein a wave crest projecting radially outwards forms the section of the cross-section of the plastic ring which can be pushed inwards and springs outwards in a radial direction.

A further preferred embodiment is characterized in that the plastic ring—which has an outer surface of an approximately cylindrical design—is provided with a rib projecting radially beyond the outer surface, which rib forms the section of the cross-section of the plastic ring which can be moved inwards and springs outwards in a radial direction, with the rib suitably being designed so as to be inclined obliquely to the axis of the plastic ring, preferably at an angle of between 35° and 75°.

Preferably, the section which can be pushed inwards and springs outwards in a radial direction extends across only a portion of the periphery of the plastic ring, preferably across at least 80% of the periphery.

In practice, it has been shown that, for the plastic ring, a wall thickness of between 0.7 and 3 mm, preferably of between 1.3 and 1.8 mm, is sufficient, wherein, in case a rib projecting radially outwards has been designed, said rib has a smaller wall thickness than the remaining cross-section of the plastic ring.

Suitably, the plastic ring is formed from one of the following materials: polyamide (PA), polyacetal (POM), thermoplastic polyesters (PET), HT-polymers (PEEK, PSU), polyethylene (PE), polypropylene (PP), polyvinyl chloride (PVC).

For particularly tough operational uses, the plastic ring is characterized in that it is designed with a fibre reinforcement, for example a glass-fibre reinforcement.

Below, the invention is illustrated in further detail by way of two exemplary embodiments depicted in the drawing, wherein

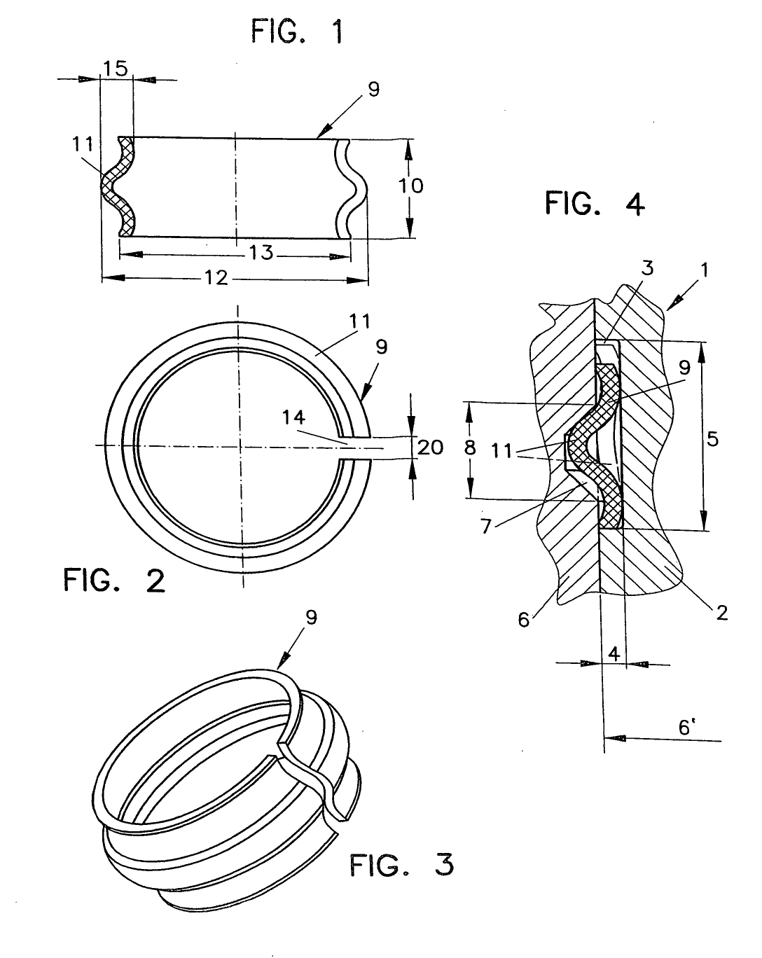

FIG. 1 shows a cross-section through a plastic ring,

FIG. 2 shows a top view and

FIG. 3 shows an oblique view of the plastic ring according to a first embodiment.

In FIG. 4, the plastic ring is shown in the fitted state.

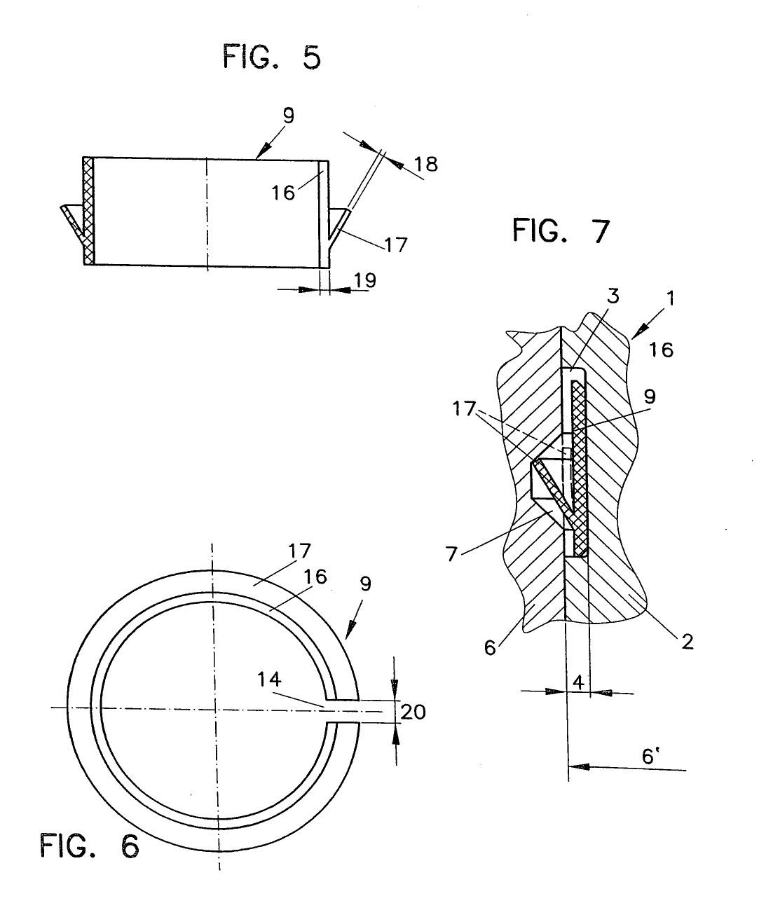

FIG. 5 in turn depicts a cross-section of the plastic ring, and

FIG. 6 shows a top view of said ring according to a second embodiment.

FIG. 7 in turn illustrates the plastic ring in the fitted state.

As can be seen from FIG. 4, a rounded-shaft tool 1 exhibits an annular groove 3 running around the tool shaft 2 and having a particular depth 4 and a particular width 5. On the level of said annular groove 3, a tool bushing 6, into which the rounded-shaft tool 1 is inserted, is also provided on the inside with an annular groove 7, which, however, has a smaller width 8 than the annular groove 3. For detachably fastening the rounded-shaft tool 1 in the tool bushing 6, a plastic ring 9 is provided which, according to the embodiment illustrated in FIGS. 1 to 4, has a wavelike cross-section. Approximately in the centre of the width 10 of said plastic ring 9, a section 11—hereinafter, also referred to as rib 11—projects with its outside diameter 12 beyond the outside diameters 13 of the two ends of the plastic ring 9. As can be seen from FIG. 2, the plastic ring 9 is provided with a slot 14. Its largest thickness 15 exceeds the depth 4 of the annular groove 3 of the rounded-shaft tool 1 if the plastic ring 9 is in the relaxed position as shown in the figures so that it exceeds the inside diameter 6′ of the tool bushing.

The insertion and removal of the rounded-shaft tool 1 into the and from the tool bushing 6, respectively, is possible because the protruding rib 11 can be pushed back, namely so far back that it will eventually lie within the annular groove 3 of the rounded-shaft tool 1. The result is an enlargement of the width 10 of the plastic ring 9, for which reason the width 5 of the annular groove 3 of the rounded-shaft tool 1 is dimensioned such that the plastic ring 9 will fit within the annular groove 3 also in the, so to speak, flattened state. Said flattened state of the plastic ring 9, i.e., of rib 11 which has been pushed back, is illustrated with dashed lines in FIG. 4.

According to the embodiment illustrated in FIGS. 5 to 7, the plastic ring 9 comprises a rib 17 projecting radially outwards from an approximately cylindrically shaped, ring-shaped base body 16 of the plastic ring 9 and oriented obliquely toward one end of the plastic ring 9, the wall thickness 18 of said rib being configured slightly smaller than the wall thickness 19 of the cylindrical base body 16. This plastic ring 9 is also designed in a slotted fashion so that it can be slid onto the rounded-shaft tool 1. As can be seen from FIG. 7, the circularly cylindrical base body 16 lies against the groove bottom of the annular groove 3 of the rounded-shaft tool 1, and the rib 17 projects in the relaxed state into the annular groove 7 of the tool bushing 6.

As can be seen in particular from FIG. 7, the thickness 19 of the circularly cylindrical base body 16 of the plastic ring 9 is dimensioned such that, when the rounded-shaft tool 1 is inserted into the tool bushing 6, a spring-deflection of the protruding rib 17 toward the base body 16 is possible and, in this spring-deflected state, the depth 4 of the annular groove 3 of the rounded-shaft tool 1 is not exceeded by the plastic ring 9. Said spring-deflected state of the rib 17 is illustrated with dashed lines in FIG. 7.

In this embodiment, the removal of the rounded-shaft tool 1 usually involves the destruction of the plastic ring 9, i.e., the protruding rib 17 will, for the most part, tear off from the circularly cylindrical base body 16 of the plastic ring 9 or will be sheared off, respectively.

The protruding ribs 11 and 17 do not have to extend across the entire periphery of the plastic ring 9, neither according to one embodiment, nor according to the other embodiment; they can also be used in a combined fashion, i.e., with a rib 17 according to FIG. 5 extending across one portion of the periphery and a rib 11 according to FIG. 1 extending across another portion of the periphery.

Preferably, the plastic ring 9 is formed from the following materials: polyamide (PA), polyacetal (POM), thermoplastic polyesters (PET), Hat-polymers (PEEK, PSU), polyethylene (PE), polypropylene (PP), polyvinyl chloride (PVC), optionally with or without a fibre reinforcement, in particular a glass-fibre reinforcement. The slot 14 can extend in the axial direction of the plastic ring 9 or also at an angle thereto of up to 45°. The width 20 of the slot 14 is between 1 and 8 mm, preferably 4 mm.

1. A plastic ring (9) for detachably fixing a rounded-shaft tool (1) into a tool bushing (6), wherein the inside of the tool bushing (6) has an annular groove (7), into which the elastic plastic ring (9) held in an annular groove (3) of the tool shaft (2) engages, with the plastic ring (9) being designed in a slotted fashion and having at least one rib projecting beyond the outer surface of the plastic ring (9) and extending across at least a portion of the periphery of the plastic ring (9), characterized in that the cross-section of the plastic ring (9) exhibits a section (11, 17) which can be pushed inwards and springs outwards in a radial direction and extends across at least a portion of the periphery of the plastic ring (9), wherein said section (11, 17) can be pushed relative to the other sections of the cross-section of the plastic ring (9) from a relaxed initial position with a particular outside diameter (12) larger than the inside diameter (6′) of the tool bushing (6) into a fitting position exhibiting a smaller outside diameter corresponding to the inside diameter (6′) of the tool bushing (6) and is able to spring back into the relaxed initial position, whereby either the total thickness (15) of the relaxed plastic ring (9) exceeds the depth (4) of the annular groove (3) of the tool shaft (2) or the slot (14) has a width (20) which is dimensioned such that, with a reduction in the diameter of the plastic ring (9) until the side walls of the slot (14) contact each other, the radially elastic section (11, 17) of the cross-section of the plastic ring (9) projects beyond the outside diameter of the tool shaft (2) when the plastic ring (9) is inserted in the annular groove (3).

2. A plastic ring (9) according to claim 1, characterized in that its cross-section has a wavelike design, wherein a wave crest projecting radially outwards forms the section (11) of the cross-section of the plastic ring (9) which springs inwards and outwards in a radial direction.

3. A plastic ring (9) according to claim 1, characterized in that it is provided with a radially projecting rib (17) which forms the section of the cross-section of the plastic ring (9) which can be pushed inwards and springs outwards in a radial direction.

4. A plastic ring (9) according to claim 3, characterized in that the rib (17) is designed so as to be inclined obliquely to the axis of the plastic ring (9), preferably at an angle of between 35 and 75°.

5. A plastic ring (9) according to claim 1, characterized in that the section (11, 17) which can be pushed inwards and springs outwards in a radial direction extends across only a portion of the periphery of the plastic ring (9), preferably across at least 80% of the periphery.

6. A plastic ring (9) according to claim 1, characterized in that its wall thickness (14) ranges between 0.7 and 3 mm, preferably between 1.3 and 1.8 mm, wherein, in case a rib (17) projecting radially outwards has been designed, said rib has a smaller wall thickness (18) than the remaining cross-section of the plastic ring.

7. A plastic ring (9) according to claim 1, characterized in that it is formed from one of the following materials: polyamide (PA), polyacetal (POM), thermoplastic polyesters (PET), HT-polymers (PEEK, PSU), polyethylene (PE); polypropylene (PP), polyvinyl chloride (PVC).

8. A plastic ring (9) according to claim 1, characterized in that it is designed with a fiber reinforcement, for example, a glass fiber reinforcement.
